(19) United States
(12) Patent Application Publication
(10) Pub. No.: US 2026/0300790 A1
(43) Pub. Date: Oct. 1, 2026

(54) MONTE CARLO INTEGRATION USING AN OPTICAL QUANTUM COMPUTER

(71) Applicant: Universiteit Twente, Enschede (NL)

(72) Inventors: Jelmer Jan RENEMA, Enschede (NL); Teun Idzard ROELINK, Enschede (NL); Malaquias CORREA ANGUITA, Enschede (NL)

(21) Appl. No.: 19/478,681

(22) PCT Filed: Mar. 21, 2024
(86) PCT No.: PCT/NL2024/050144

§ 371 Date: Oct. 24, 2025

(30) Foreign Application Priority Data
Apr. 25, 2023 (NL) 2034688

(51) Int. Cl. G06N 10/40

(52) U.S. Cl. CPC G06N 10/40

(57) ABSTRACT

Methods and systems for computing a Monte Carlo integral using a boson sampler are described. The method may include receiving an input function, the input function being the product of a probability function g(x) that can be implemented by one or more calls to a programmable boson sampler characterized by unitary U and a set of input quantum states and photodetection in a definite basis and a function h(x) that can be efficiently evaluated by a classical computer; encoding the probability function into a boson sampler; generating samples from the probability function based on the boson sampler; evaluate values of the function h(x) at the sample values; and, computing an estimate of the integral of the input function by summing the evaluated values of the function h(x).

### TECHNICAL FIELD

The disclosure generally relates to Monte Carlo integration, and in particular, though not exclusively, to methods and systems for Monte Carlo integration of a function using an optical quantum computer, such as a boson sampler, and computer program product using such methods.

### BACKGROUND

Quantum photonics is one of the leading platforms for realizing large-scale quantum computing. It is one of two technology platforms which has successfully demonstrated a quantum advantage, i.e., the situation where a quantum device outperforms a classical computer at a specific computational task. In quantum photonics, information is encoded in the positional degree of freedom of photons, which then undergo quantum interference in a linear-optical system.

When measured in the Fock basis, the output samples (i.e., patterns of detection events) come from a distribution which cannot be efficiently sampled from using classical resources, thereby demonstrating its nature as a quantum computational model. Experimental implementations of this protocol constitute some of the largest controlled quantum systems in the world, at over 100 photons. A direct simulation of such a system on the world's largest supercomputer is estimated to require 150 billion years per sample.

A key challenge for photonic quantum computing is that, at least in the near-term implementation described above, it is a form of non-universal quantum computation, which does not naturally map onto the qubit-based picture in which most algorithms are developed. This means that specific algorithms must be developed that leverage the unique encoding used in quantum photonics. Developing such algorithms has been identified by experts in the field as the most important challenge for pushing photonic quantum computing forward.

Like all quantum computing algorithms suitable for implementation in the near term, these algorithms must make use of the inherent properties of the device on which they are running. In this case, that means that applications need to be developed that naturally require drawing samples from a probability distribution which cannot be efficiently sampled from classically, but which can be implemented using photonics. Recent developments in linear optics have substantially broadened the class of probability distributions which can be implemented in this way.

One particular application that is based on the sampling problem relates to Monte Carlo integration, as e.g. described in the article by the article by S. Herbert, Quantum Monte Carlo Integration: the full advantage in minimal circuit depth, arXiv:2105.09100 (2021). Monte Carlo integration regards the process of solving integrals that are hard to compute deterministically, by random sampling from a distribution. Monte Carlo integration is used for example used in finance for addressing problems in option pricing. This article theoretically shows that quantum amplitude estimation (QAE) can be used to compute such integrals. QAE requires a universal qubit-based quantum computer and fault tolerance, thereby requiring techniques such as quantum error correction. Practical implementations for Monte Carlo integration on an optical quantum computer are not known.

Hence, from the above it follows that there is a need in the art for implementations of near-term applications on an optical quantum computer. In particular, there is a need in the art for computing Monte Carlo integrals using a linear-optical quantum computer.

### SUMMARY

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The embodiments in this application relate of a scheme for computing an integral of a function based on a programmable boson sampling system.

In an aspect, the embodiment may relate to a method for computing a Monte Carlo integral comprising: receiving an input function, the input function being the product of a probability function g(x) and a function h(x) that can be efficiently evaluated by a classical computer wherein the probability function is implementable using a programmable boson sampler; encoding the probability function into a boson sampler; generating samples from the probability function based on the boson sampler; evaluate values of the function h(x) at the sample values; and, computing an estimate of the integral of the input function by summing the evaluated values of the function h(x).

In an embodiment, the probability function may be characterized by a unitary U, a set of input quantum states and an output based on photodetection in a basis, which may be chosen by the user.

In an embodiment, the implementation of the probability function may include one or more calls to the programmable boson sampler.

The output probability distribution of the boson sampling system may be used to draw samples from distributions which are classically inefficient to sample from. These samples are used for computing the integration of multi-dimensional functions using the Monte Carlo method, a technique wherein the integral is evaluated using the samples. The boson sampling system can be implemented as a linear optical network and used as an efficient co-processor for these calculations. This may be especially beneficial in fields in which high dimensional integrals are commonly used, such as path integrals in particle physics and many body problems in quantum chemistry. More generally, Monte Carlo integration finds applications across disciplines, including statistical physics, finance, and engineering.

In an embodiment, the encoding of the probability function may include decomposing the probability function g(x) in a symmetrical product of one-dimensional functions. gᵢ(xⱼ); discretizing each of the one-dimensional functions gᵢ(xⱼ) such that the number of points is equal to N, wherein N defines the number of channels of the sampler; and, programming the first d rows of the unitary U of the boson sampler using the one-dimensional functions gᵢ(xⱼ).

In an embodiment, the unitary U may be implemented as programmable universal multiport interferometer.

In an embodiment, the encoding of the probability function may include decomposing the U matrix into a product of transmission matrices T_{m,n}, wherein a transmission matrix T_{m,n} may define a lossless beam splitter between channel m and n based on reflectively θ and/or phase shift φ.

In an embodiment, the reflectivity and/or the phase shift parameters of the transmission matrices may be used to program the probability function into the universal multiport interferometer.

In an embodiment, the programmable boson sampler may be a Fock-state boson sampler, a Gaussian boson sampler, a scattershot boson sampler Bipartite boson sampler or a superposition boson sampler, or a boson sampler taking as its input any other quantum state of light.

In a further aspect, the embodiments may relate to a system for computing a Monte Carlo integral including classical computer connected to a programmable boson sampler, the system being configured to: receive an input function, the input function being the product of a probability function g(x) that can be implemented by one or more calls to a programmable boson sampler and a function h(x) that can be efficiently evaluated by a classical computer; encoding the probability function into a boson sampler; generate samples from the probability function based on the boson sampler; evaluate values of the function h(x) at the sample values; and, compute an estimate of the integral of the input function by summing the evaluated values of the function h(x).

In an embodiment, the programmable boson sampler may be characterized by an unitary U, a set of input quantum states and photodetection in a definite basis

The embodiments may also relate to a computer program or suite of computer programs comprising at least one software code portion the software code portion, when run on a computer, being configured for executing the method steps according any of claims.

### BRIEF DESCRIPTION OF THE DRAWINGS

FIG. 1 depicts a hybrid computer system including an optical quantum computer and a classical computer;

FIG. 2A-2C schematically depict an example of a boson sampler;

FIG. 3 depicts a schematic of a system for computing a Monte Carlo integral of a function using a boson sampler;

FIG. 4 depicts a method for computing a Monte Carlo integral using a boson sampler;

FIG. 5 depicts a method of programming a boson sampler;

FIG. 6 depicts an example of a 3 photon/6 mode boson sampling PDF and CDF;

FIG. 7 shows the Monte Carlo integration with samples drawn from the boson sampling output distribution

FIG. 8 depicts the average constant error as a function of the number of photons,

FIG. 9 depicts the average constant error as a function of the power term

FIG. 10 shows the average constant error as function of the number of modes

FIG. 11 depicts the average constant error as a function of the power term.

### DESCRIPTION OF THE EMBODIMENTS

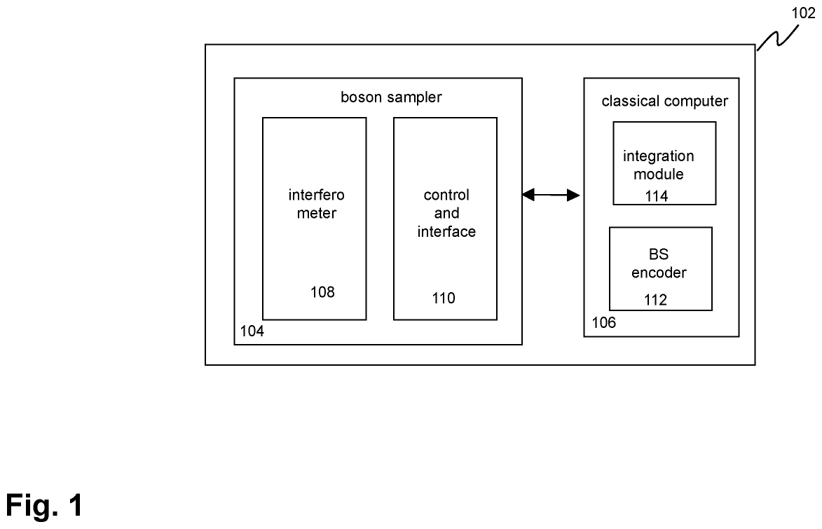

FIG. 1 depicts a hybrid computer system including an optical quantum computer and a classical computer. In particular, the figure depicts a hybrid computer system 100 including a boson sampler (BS) 104 and a classical computer 106. The boson sampler may include a programmable interferometer 108 in which a probability function can be encoded in terms of optical modes. This way, the boson sampler can be used for performing a complex computation such as Monte Carlo integration. The programmable interferometer may include a controller 110 for programming the interferometer and for controlling the programmed interferometer. In particular, the controller may include laser and detectors to control the sampling process. Further, the classical computer may include software and/or hardware modules which are configured to execute software code. An encoder module 112 may be configured to encode certain functions, such as a probability function, into the interferometer. so that samples can be drawn from a predetermined probability function. An integration module 114 may be configured to prepare an input function for a Monte Carlo integration scheme, to request samples from the boson sampler and to compute an estimate of the integral based on the samples. The photonic boson sampler may be used by the classical computer to deal with parts of integration computation that are computational hard for the classical computer.

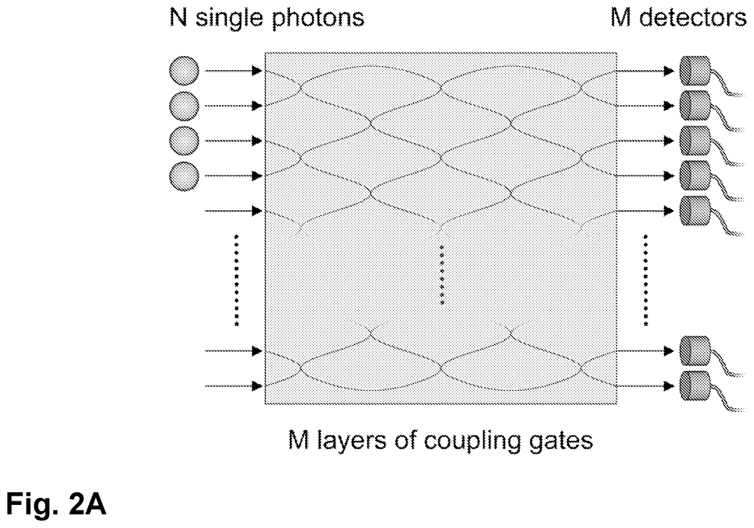

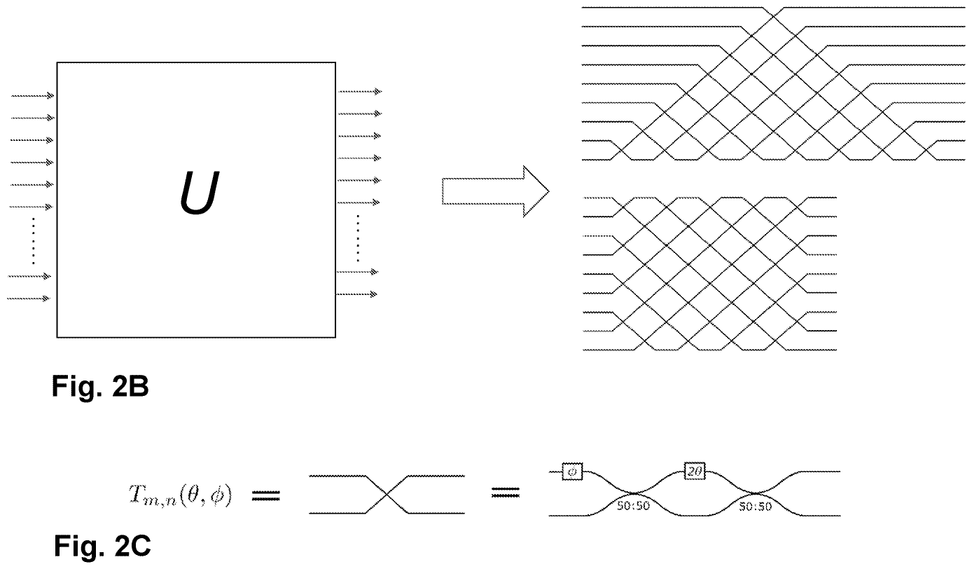

FIG. 2A-2C schematically depict an example of a boson sampler (BS) which may be used in the embodiments described in the application. In particular, FIG. 2A depicts a boson sampler that is implemented based on a reconfigurable universal multiport interferometer comprising N input ports and M output ports. The BS further includes N indistinguishable optical sources 204 wherein each optical source 206 is connected to an input port of the interferometer 202 and is configured to generate single photons. Alternatively, in another embodiment, the optical sources may procedure single mode squeezed vacuum states SMSVs. The BS quantum hardware system further includes M single photon detectors 208 for detecting photons at the M output ports of the BS sampler. It is noted that FIG. 2A only illustrates a non-limiting example of a multiport interferometer that can be used with the embodiments described in this application. For example, instead of single photon detectors, detection techniques like photon number resolving detection, homodyne detection or heterodyne detection may be used.

FIG. 2B illustrates a reconfigurable universal multiport interferometer which is characterized by matrix U which may describe the internal optical structure of the interferometer that includes beam splitters and phase shifters in terms of matrix elements. As shown in this figure, different optical arrangements are possible including a design by Reck at et. Experimental realization of any discrete unitary operator,” Physical Review Letters, vol. 73, no. 1, p. 58, 1994 and the design by Clements et al, An optimal design for universal multiport interferometers, (https://doi.org/10.1364/OPTICA.3.001460). Further, an optical platform for a quantum photonic processor that can be used for implementing the embodiments in this disclosure is described in the articles by Taballione et al, 20-Mode Universal Quantum Photonic Processor, arXiv:2203.01801v5 and Taballione et al., A universal fully reconfigurable 12-mode quantum photonic processor, Mater. Quantum Technol. 1 (2021) 035002. These documents are hereby incorporated by reference into this application.

Matrix U may be decomposed into a product of T_{m,n} matrices: U=D(Π_{(m,n)∈S}T_{m,n}) wherein a T_{m,n} matrix may define a lossless beam splitter between channel m and n with reflectively θ and phase shift φ as illustrated in FIG. 2C.

The interference between photons is the backbone of quantum information processing on a linear optical network as described above with reference to FIG. 2A-2C. The interference may be described using the Fock basis. This process may be explained based on a simple two-particle interference setup that has two input and two output modes. With the help of the creation operator

$${\hat{a}}_{i}^{†} ,$$

which simply adds a photon to the i^{th} i^{th} mode, a general input state can be described (equation 1):

$$\vert {Ψ}_{in} 〉 = \vert 1 , 1 〉 = {\hat{a}}_{1}^{†} {\hat{a}}_{2}^{†} \vert 0 , 0 〉$$

here the input modes are numbered 1 and 2 and the creation operators act on the vacuum state |0 [symbol] . With the help of a unitary matrix (equation 2):

$${U}_{bs} = \frac{1}{\sqrt{2}} ( \begin{matrix}1 & 1 \\ 1 & - 1\end{matrix} )$$

depicting the beam splitter, creation for the output modes

$${b}_{i}^{†} ,$$

can be determined (equation 3):

$$( \begin{matrix}{\hat{b}}_{1}^{†} \\ {\hat{b}}_{2}^{†}\end{matrix} ) = \frac{1}{\sqrt{2}} ( \begin{matrix}1 & 1 \\ 1 & - 1\end{matrix} ) ( \begin{matrix}{\hat{a}}_{1}^{†} \\ {\hat{a}}_{2}^{†}\end{matrix} )$$

where the output state is expressed with operators

$${b}_{1}^{†} and {b}_{2}^{†}$$

acting on the vacuum state (equation 4):

$$\vert {Ψ}_{out} 〉 = {\hat{b}}_{1}^{†} {\hat{b}}_{2}^{†} \vert 0 , 0 〉$$

which can be rewritten to (equation 5):

$$\vert {Ψ}_{out} 〉 = \frac{1}{2} ( {\hat{a}}_{1}^{†} + {\hat{a}}_{2}^{†} ) ( {\hat{a}}_{1}^{†} - {\hat{a}}_{2}^{†} ) \vert 0 , 0 〉 = \frac{1}{2} ( {\hat{a}}_{1}^{† 2} - {\hat{a}}_{2}^{†2} + {\hat{a}}_{1}^{†} {\hat{a}}_{2}^{†} - {\hat{a}}_{2}^{†} {\hat{a}}_{1}^{†} ) \vert 0 , 0 〉$$

creating four final terms, each representing a travel option for the photon, FIG. 2. For fully indistinguishable photons, photons with identical degrees of freedom, such as polarization, frequency or arrival time, the creation operators commute

$$[ {\hat{a}}_{1}^{†} , {\hat{a}}_{2}^{†} ] = 0 ,$$

and drop from the expression, resulting in the final output state (equation 6):

$$\vert {Ψ}_{out} 〉 = \frac{1}{2} ( {\hat{a}}_{1}^{†2} - {\hat{a}}_{2}^{†2} ) \vert 0 , 0 〉 = \frac{1}{\sqrt{2}} ( \vert 2 , 0 〉 - \vert 0 , 2 〉 )$$

showing the photons must leave the beam splitter together. Note that the creation operator includes the normalization factor that depends on the number of photons in the mode. The latter two terms will not destructively interfere when the photons are not indistinguishable, due to their no longer commuting operators,

$$[ {\hat{a}}_{1}^{†} , {\hat{a}}_{2}^{†} ] \neq 0 .$$

The probability of detecting the |1,1 [symbol] output state is therefore dependent on the partial distinguishability of the photons.

The two-particle interference setup can be expanded to a more general n particle description using a linear optical network containing a series of beam splitters and phase shifters. The input state of the system contains n photons in m modes (equation 7):

$$\vert {Ψ}_{in} 〉 = \vert {n}_{1} , {n}_{2} , … , {n}_{m} 〉 = {\prod }_{i = 1}^{m} \frac{{\hat{a}}_{i}^{† {n}_{i}}}{\sqrt{{n}_{i} !}} \vert 0 〉$$

where the normalization constant, used before in equation 4, is added to correct for the multiplicity of output states. Following the steps as before, the output creation operators are a function of the input creation operators and the m·m size unitary matrix U (equation 8):

$$( \begin{matrix}{\hat{b}}_{1}^{†} \\ {\hat{b}}_{2}^{†} \\ ⋮ \\ {\hat{b}}_{m}^{†}\end{matrix} ) = U ( \begin{matrix}{\hat{a}}_{1}^{†} \\ {\hat{a}}_{2}^{†} \\ ⋮ \\ {\hat{a}}_{m}^{†}\end{matrix} )$$

The general expression for the output state can be described by combining both expressions (equation 9):

$$\vert {Ψ}_{o u t} 〉 = {\prod }_{i = 1}^{m} {\sum }_{j = 1}^{m} {U}_{i , j} \frac{{a}_{j}^{† {n}_{j}}}{\sqrt{{n}_{j} !}} \vert 0 〉$$

where i indicated the rows and j the columns of the unitary matrix. An alternative way to express equation 9 is to use the permanent function of the unitary matrix (equation 10):

$$per ( U ) = {\sum }_{σ ∈ S} {\prod }_{i = 1}^{n} {U}_{i , σ ( i )}$$

The permanent of a matrix is analogous to the determinant except for the fact that the sign of the product of elements remain positive instead of alternating signs. The summation is altered to run over every combination, σ, in which n photons can be distributed over m modes, which is a function of the number of photons, n, and modes,

$$m , ( \begin{matrix}m + n - 1 \\ n\end{matrix} ) {<}_{∼} {m}^{n}$$

for m>>n. As an example, there are six combinations to distribute two photons in three modes, i.e. |2,0,0 [symbol] , |0, 2, 0 [symbol] , |0, 0, 2 [symbol] , |1, 1, 0 [symbol] , |1, 0, 1 [symbol] , |0, 1, 1 [symbol] . In that case, the output state can be based on the permanent using the following expression 10:

$$\vert {Ψ}_{out} 〉 = {\sum }_{S} {γ}_{S} \vert {n}_{1}^{( S )} , {n}_{2}^{( S )} , … , {n}_{m}^{( S )} 〉 , {γ}_{S} = \frac{Per ( {U}_{S} )}{\sqrt{{n}_{1}^{( S )} ! \cdot {n}_{2}^{( S )} ! … \cdot {n}_{m}^{( S )} !}}$$

wherein Uₛ is a n·n sub-matrix of U with rows corresponding to the input configuration and columns to the output configurations S.

The many-particle interference effect can be used in a linear optical network, known as boson sampling. Single photons are sent through the first n input modes and with the help of beam splitters and phase shifters an output state is detected with a certain probability. The amount of interference can be tuned by adjusting the coupling strength in the beam splitters, resulting in a desired output probability distribution (equation 11):

$${P}_{S} = 〈 {Ψ}_{out} \vert {Ψ}_{out} 〉 = {\vert {γ}_{S} \vert}^{2} ∝ {\vert Per ( {U}_{S} ) \vert}^{2}$$

which can be computed with the inner product of expression 10.

Equation 11 illustrates the proportionality of the probability distribution to the matrix permanent. The computational hardness of boson sampling arises from the implementation of independent and identically distributed Gaussian matrices. This property is inherent to Haar random matrices which are therefore often used in such applications. The summed probability distribution of many Haar random matrices creates a uniform distribution over all output states. A classical computation requires exponentially increasing resources as the network size is increased. Since the boson sampling experiment is a sampling problem, it cannot be used to calculate the matrix permanent, as it would require an exponentially increasing number of measurements.

Numerical integration of multi-dimensional function can be based on various techniques. When using a Riemann sum, the integration region is divided into n segments of equal length Δx and heights according to the function value. The summation of the area of these segments converge to the integral value with increasing number of segments i.e. when Δx becomes infinitesimally small. The convergence of the approximation to the actual value is an important metric for comparing numerical integration techniques when looking at multi-dimensional functions. Naturally the fastest convergence is preferred in order to reduce the number of computations needed to reach a certain error. Computing integrals based on this simple approximation technique may become a challenge when integrating multi-dimensional functions because the number of segments required to divide the integration region increases exponentially with n^{d}, where d is the number of dimensions. Consequently, to achieve a certain approximation accuracy, exponentially more segments need to be computed. This leads to an increase in the approximation error, which scales as

$$𝒪 ( \frac{1}{{n}^{1 / d}} ) .$$

This phenomenon is commonly referred to as the curse of dimensionality.

Monte Carlo integration provides an alternative way for computing an integral. It is based on randomly selected coordinates within the integration region for evaluating the function. Similar to the Riemann sum, the function value is equivalent to the height of the segment. In contrast, the width of the segment now covers the entire integration region. By repeating this process N times, with N→∞, and taking the average of the segment areas, the law of large numbers guarantees the convergence of the approximation towards the actual integral value. The sum of the function values at the sampled points can be used to approximate the integral (equation 12):

$$I = {\int }_{a}^{b} f ( x ) \approx \frac{b - a}{N} {\sum }_{i = 1}^{N} f ( {x}_{i} )$$

with the integration volume specified by a and b, xᵢ the i^{th} sampled coordinate and N the total number of samples. Expanding to multiple dimensions, it can be observed that unlike the Riemann sum, the number of computations does not scale exponentially. The approximation error for the Monte Carlo method scales as

$$𝒪 ( \frac{1}{\sqrt{N}} )$$

independent of the dimensions of the integral, which makes it an excellent candidate for high dimension integrals. The Monte Carlo technique approaches the integral value faster for three or more dimensional problems.

The use of samples in the Monte Carlo method is not limited to a specific distribution, like uniformly drawn samples. In fact, it is usually beneficial to sample according to a probability distribution which is as similar as possible to the original function, i.e. where

$$\frac{f ( x )}{g ( x )} \approx C ,$$

where C is a constant. In the case where samples are chosen from a probability distribution g(x), equation 12 can be rewritten as follows (equation 13):

$$I \approx \frac{b - a}{N} {\sum }_{i = 1}^{N} \frac{f ( {x}_{i} )}{g ( {x}_{i} )}$$

Here, function g(x) is the probability density function according to which samples are drawn. Using this technique for high dimensional integrals may still be challenging as the structure of the function is often not known beforehand and therefore picking a function g(x) proportional to f(x) may be difficult. Furthermore, regions where the function highly varies can also occupy only a fraction of the total integration volume, especially for high dimensional systems. Adaptive strategies are often used to predict where these regions can be found. Lastly and most important, if a correct probability distribution is found, there is no guarantee it will be efficient to sample from classically, functions containing the matrix permanent for example.

The application of boson sampling allows efficient sampling from probability distributions, which otherwise cannot be efficiently sampled by classical means. It is therefore possible to use the linear optical network as a co-processor to efficiently draw samples and use these samples to efficiently evaluate a function classically. When both these processes are efficient, a quantum advantage for this computation exists. In order to implement boson sampling in the Monte Carlo technique, the function is written as a product of two functions (equation 14):

$$I = {\int }_{a}^{b} f ( \hat{X} ) = {\int }_{α}^{b} g ( \hat{X} ) \cdot h ( \hat{X} ) \approx \frac{b - a}{N} {\sum }_{g ( \hat{X} )} h ( \hat{X} )$$

with the integration volume specified by a and b, \hat{X} the set of dimensions, (x₁, x₂, . . . , x_{d}), g(\hat{X}) the probability distribution efficiently sampled using an optical network, a boson sampler, and h(\hat{X}) a function which can be efficiently evaluated classically. The output distribution is sampled with the photons in a numbered output mode, which is used in function h(\hat{X}). The structure of this function is dependent on the original function and can therefore be adjusted accordingly.

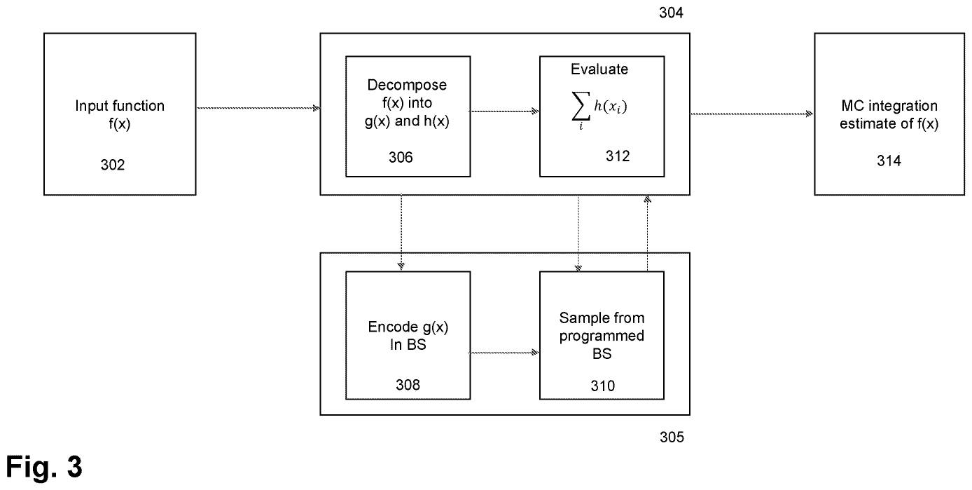

FIG. 3 depicts a schematic of a system for computing a Monte Carlo integral of a function using a boson sampler. It includes a classical computer 304 connected to a boson sampler 305. The classical computer may include one or more modules, e.g. software modules and/or hardware modules including an input for receiving an input function for which an integral needs to be computed. One module 306 in the classical computer may be configured to decompose the function into a probability function g(x) that can be implemented in a programmable boson sampler and a function h(x) that can be evaluated classically. The computer may further include an encoder module 308 that is configured to encode (program) the probability function into the boson sampler. The programmed sampler 310 is then used to generate samples from the probability function and these samples are subsequently used by an evaluation module 312 to evaluate the values of h(x) at the sample values. The output of the classical computer may include the sum of the evaluated values of h(x) forms the estimate 314 of the Monte Carlo integral of the input function.

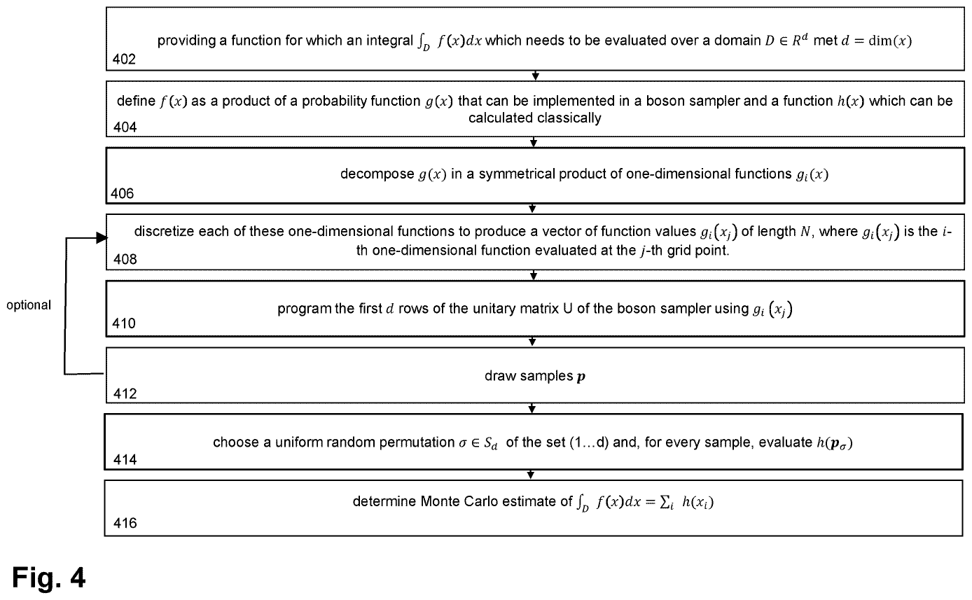

FIG. 4 depicts a schematic of a flow diagram for computing a Monte Carlo integral of a function using a boson sampler. A first step 402 may include providing a function for which an integral ∫_{D} ƒ(x) dx needs to be evaluated. The evaluation of the integral may be over a domain having a certain dimension D∈R^{d} with d=dim(x), i.e. the dimensionality of the domain of the function f. Further, (step 404) the function ƒ(x) may be defined as a product of a probability function g(x) that can be implemented in a boson sampler (characterized by a unitary matrix U, a set of input quantum states, and measurement in a user-defined measurement basis) and a function h(x) which can be efficiently calculated classically. Then, in step 406 g(x) is decomposed into a symmetrical product of one-dimensional functions gᵢ(x). Each of these one-dimensional functions is discretized to produce a vector of function values gᵢ(xⱼ) of length N (step 408), where gᵢ(xⱼ) is the i-th one-dimensional function evaluated at the j-th grid point. Then, the first d rows of the unitary matrix U of the boson sampler may be programmed based on the one-dimensional functions gᵢ(xⱼ) (step 410). Then, use the programmed boson sampler to draw samples (step 412), choose a random permutation σ∈S_{d} of the set integers (1 . . . d) and for every sample evaluate h(p_{σ}). The estimate of the Monte Carlo integral is the sum of values of h that are evaluated at the sample points, i.e. Σᵢ h(xᵢ).

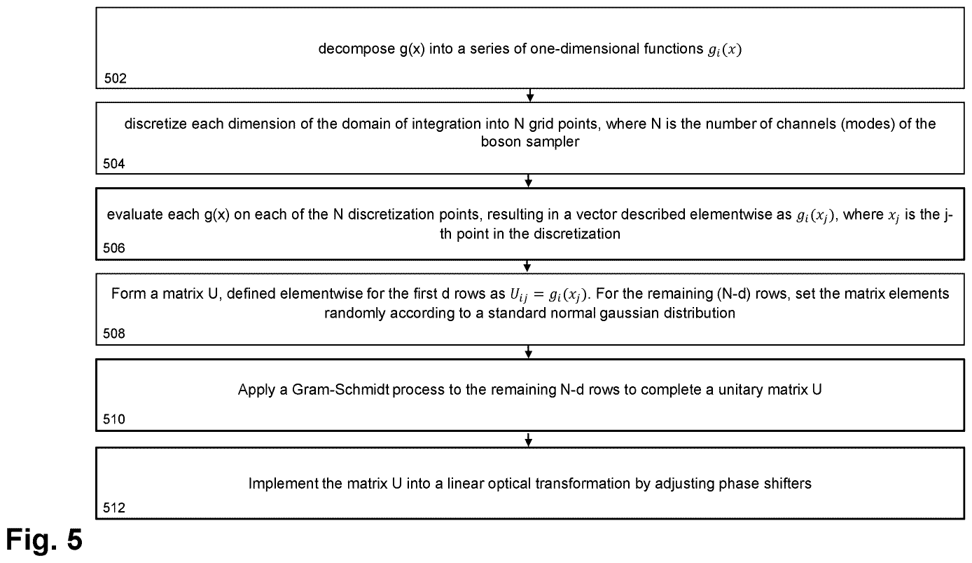

FIG. 5 depicts a method of programming a boson sampler. The method may include a step of decomposing distribution g(x) into a series of one-dimensional functions gᵢ(x) (step 502) and discretizing each dimension of the domain of integration into N grid points, where N is the number of channels (modes) of the boson sampler (step 504). Then, each g(x) is evaluated on each of the N discretization points, resulting in a vector described elementwise as gᵢ(xⱼ), where xⱼ is the j-th point in the discretization (step 506). A matrix U may be formed defined elementwise for the first d rows as Uᵢⱼ=gᵢ(xⱼ) and for the remaining (N−d) rows of U, set the matrix elements randomly according to a standard normal Gaussian distribution (step 508). A Gram-Schmidt process is applied to the remaining N−d rows to complete a unitary matrix U. The matrix U is implemented in an interferometer as a linear optical transformation by adjusting optical elements, e.g. phase shifters, of the interferometer.

Hence, the encoding of the probability function g(x) in de boson sampler may be realized in two steps. In a first step, the function is decomposed into the absolute value of a symmetrical product of one-dimensional functions. Then, in a second step, the functions are implemented in a linear optical (unitary) matrix U of an interferometer. Implementation of the functions into the linear optical matrix U is known in the art, see e.g. the article cited above by Clements et al, An optimal design for universal multiport interferometers, and by Reck at et. Experimental realization of any discrete unitary operator,” Physical Review Letters, vol. 73, no. 1, p. 58, 1994.

Physically, the optical elements of a programmable universal multiport interferometer may be tuned using heating elements and/or electro-optical elements such that Uᵢⱼ=gᵢ(xⱼ), as defined above. This defines an d-by-N block of a unitary matrix. The Gram-Schmidt process is then used to complete the unitary matrix into size N-by-N, using uniformly randomly chosen matrix elements as input.

Simulation experiments have been performed to examine the integration method. In particular, it may be determined if the error of the approximation increases exponentially when the system scale is increased. The size of the optical network can be increased with the number of photons n, which represent the number of coordinates drawn i.e. the number of dimensions and the number of output modes, m, the amount of segments that divide the integration region (where more modes is always preferred as it lowers the error of the approximation). The dependence of the approximation made in equation 14 on the number of modes may be examined. Perfectly indistinguishable photons are assumed.

Simulations have been performed to address these questions. To that end, an easy to compute a polynomial h(\hat{X}) of the following form may be used (equation 15):

$$h ( \hat{X} ) = \frac{{( {\sum }_{í = 1}^{n} {X}_{i} )}^{k}}{m}$$

where it is normalized with the total number of output modes m to create a constant integration region spanning from 0 to 1 and elements Xᵢ, sampled from the output configuration. Furthermore, the relative approximation error is expressed by (equation 16):

$${ϵ}_{r e l} = \vert 1 - \frac{{f}_{s}}{{f}_{a}} \vert$$

with the analytical value, ƒₐ(\hat{X})=Σ(PDF(\hat{X})·h(\hat{X})) and the sampled value ƒₛ(\hat{X})=Σ(g(\hat{X})·h(\hat{X})). The cumulative distribution function (CDF) is used to draw samples according to any probability distribution. The cumulative distribution evaluated at x calculates the probability of the original distribution to be x or less, namely (equation 17):

$$CDF ( x ) = {\int }_{- ∞}^{x} PDF ( x ) = {\sum }_{{x}_{i} \leq x} PDF ( {x}_{i} )$$

where the integral can be replaced with a summation for discrete variables.

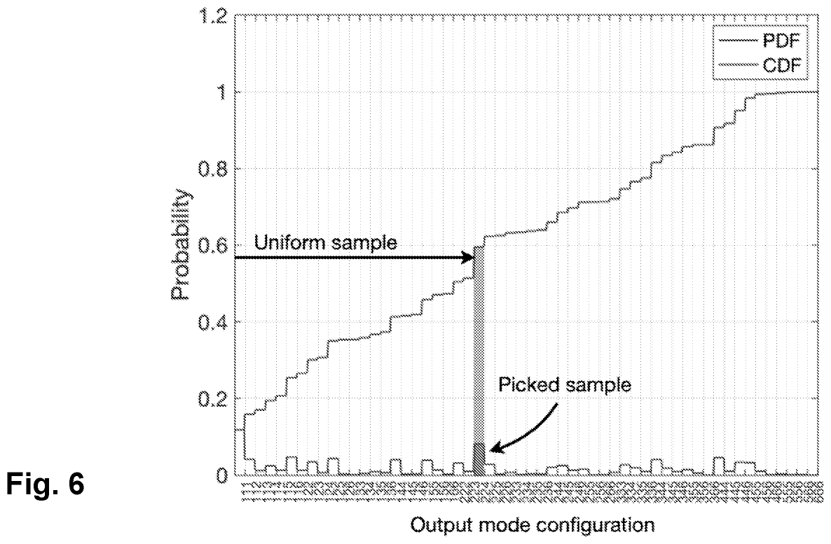

FIG. 6 depicts an example of a 3 photon/6 mode boson sampling PDF and CDF. Uniformly sampling the value of the CDF between 0 and 1 and finding the associated x coordinate creates a sampling distribution according to the probability distribution. The algorithms calculating the output distribution of a boson sampling experiment use the matrix permanent and are therefore a classically inefficient algorithm. In order to circumvent calculating the permanent, the properties of the Haar measure is used. The summed output probability of many Haar measures is a uniform probability distribution over every output state. Instead of uniformly sampling the inverse CDF, the output configurations are directly uniformly sampled.

The method is efficient if the approximation error does not exponentially increase with increasing system size, namely number of photons and number of modes. The increase of photons will add additional dimensions and thus an extra sample coordinate. The system size is varied with 2 to 15 indistinguishable photons and a constant 12 output modes, where 100 Haar random matrices are simulated with 10³ samples drawn from each distribution and an average error is taken.

The increase of output modes will increase the number of states which can be sampled from, naturally decreasing the error of the approximation as the function is divided into more segment. It is therefore preferred to use as many output modes as possible. The effect of increasing the number of modes on the approximation in expression 13 is studied, where a constant 3 indistinguishable photons and increasing number of output modes from 4 to 196 are taken and again, 100 Haar random matrices are simulated with 10³ samples and an average error is computed. For both these system size studies the polynomial according to equation 15 with increasing power term k is investigated.

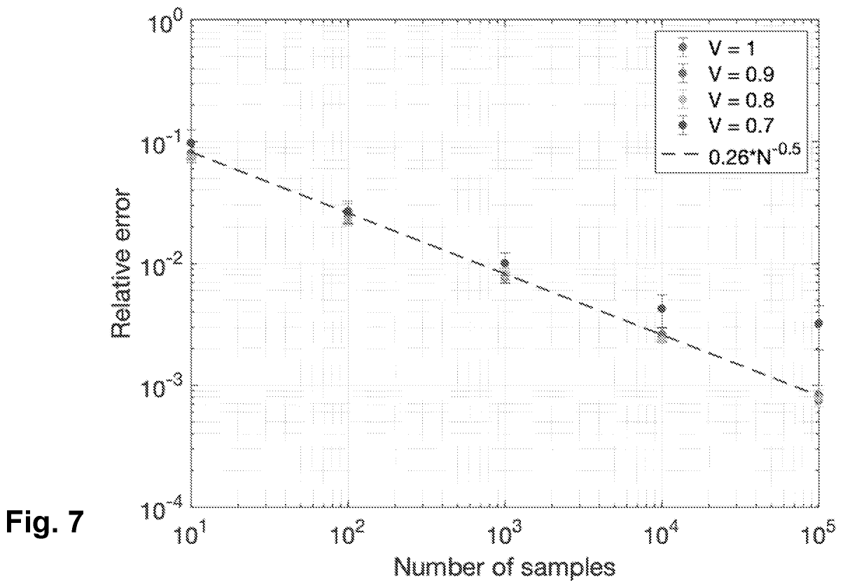

FIG. 7 shows the Monte Carlo integration with samples drawn from the boson sampling output distribution. Fully indistinguishable photons, V=1, show the predicted proportionality 1/\sqrt{N} to the number of samples. However, this is not the case for photons with partial distinguishability, specifically V=0.7, as can be expected due to the deviating probability distribution. The simulation suggests that in order to reach relative error ∈ᵣₑₗ<10⁻², the partial distinguishable starts to become important and the error diverges from the inverse root scaling when N>10³. A visibility of V>0.8 is needed to scale with the inverse root of the number of samples in the range from 10¹ to 10⁵.

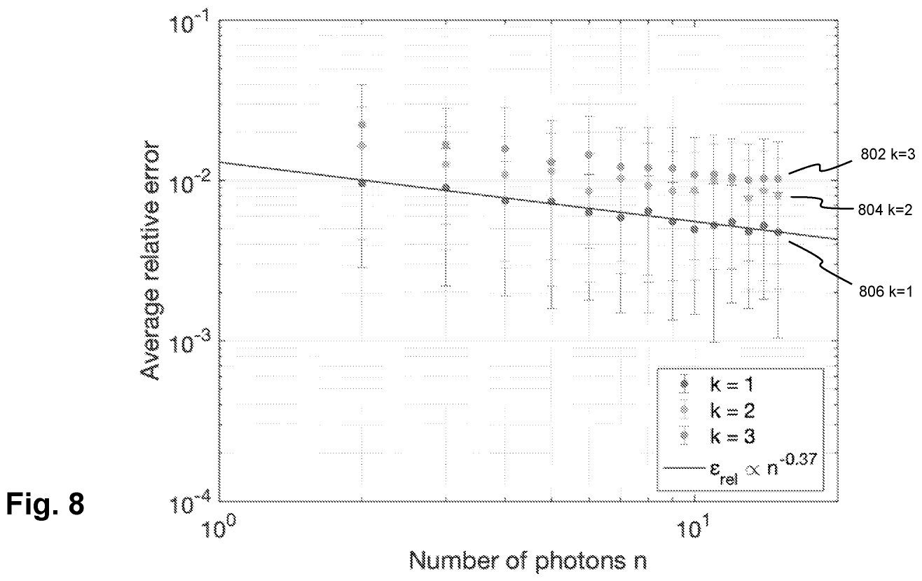

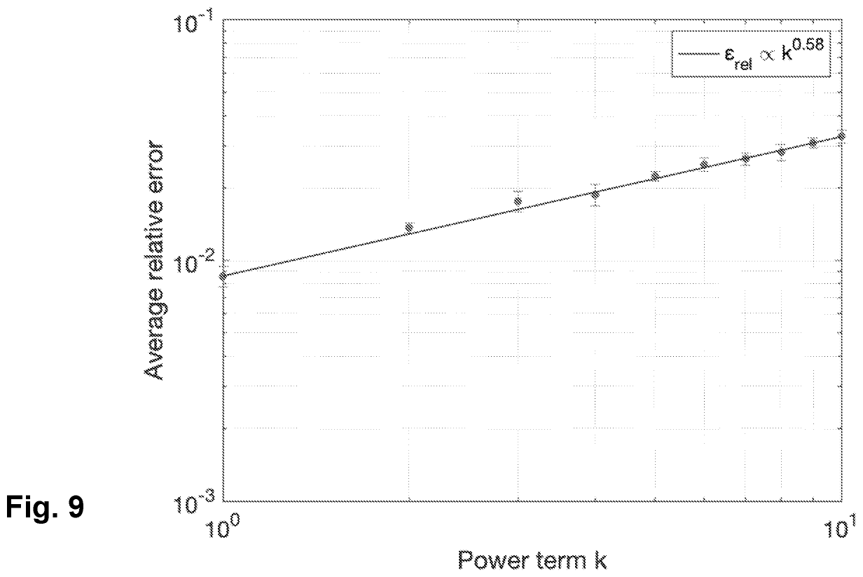

FIG. 8 depicts the average constant error as a function of the number of photons, average of 100 sets with 10³ number of samples. As shown in the figure, the relative error decreases with the number of photons proportional to n^{-0.37}. This proportionality still holds with the expanding of h(\hat{X}) to higher powers, however it increases non-linearly with higher power terms. FIG. 9 further shows the relative error as function of the power term. Here an average of 10 sets with 10³ number of samples is used. The error rises proportional to k^{0.58}, which is a sub-linear scaling. The simulation therefore indicates that it is efficient to increase the system size with the number of photons.

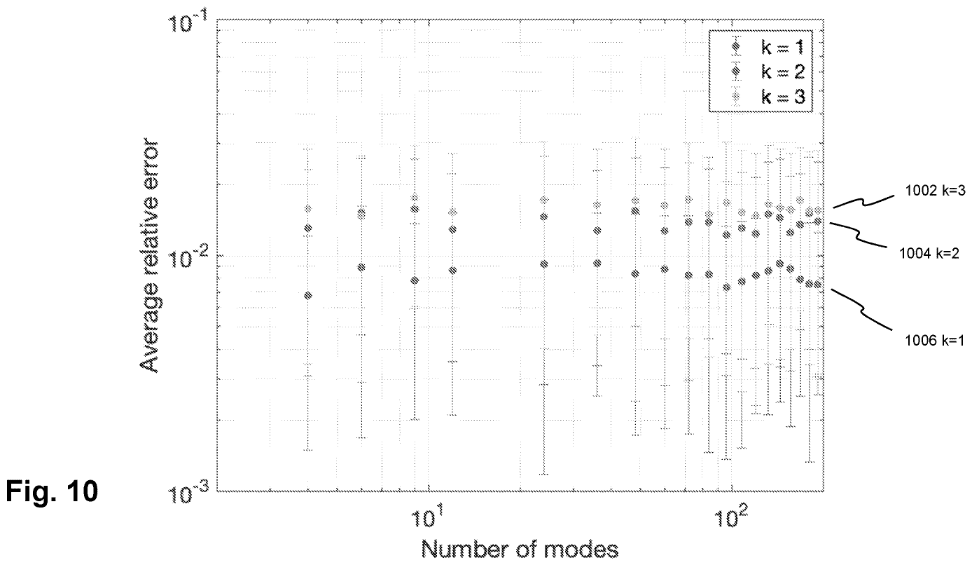

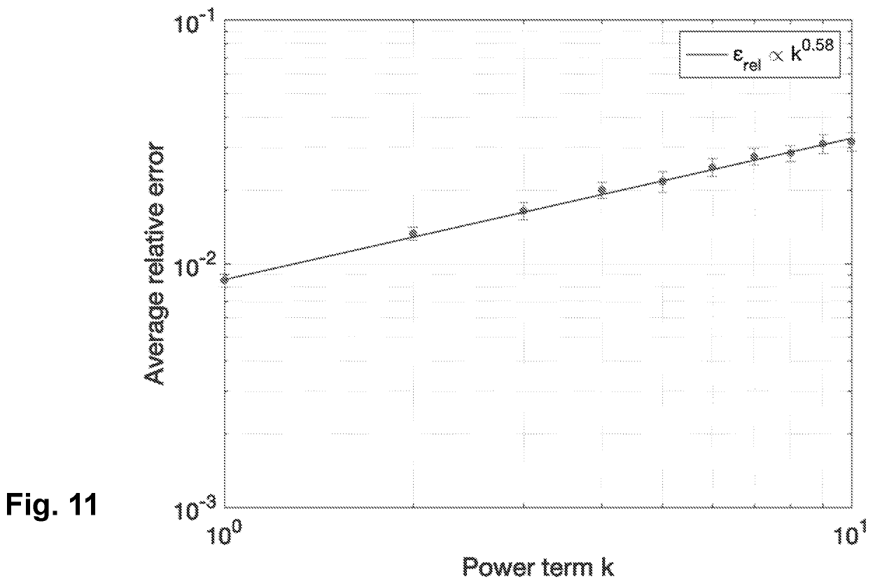

FIG. 10 shows the average constant error as function of the number of modes. The figure shows that it remains constant over the simulated region. This indicates that the approximation made in equation 14 is valid and no additional error is created with increasing output modes. The scaling with the power term also shows the error remains constant for higher order polynomials and it increases non-linear. FIG. 11 depicts the average constant error as a function of the power term. The proportionality constant regarding the increase of the average relative error as a function of the number of photons is found to be k^{0.58}. These figures show that the number of modes can be increased without adding additional error and is thus efficient for system sizes with arbitrary number of output modes.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments.

1. A method for computing a Monte Carlo integral, the method comprising:
receiving an input function, the input function being the product of a probability function g(x) that can be implemented by one or more calls to a programmable boson sampler and a function h(x) that can be evaluated by a classical computer, wherein the boson sampler is characterized by unitary U, a set of input quantum states and photodetection in a definite basis;
encoding the probability function into the boson sampler;
generating samples from the probability function based on the boson sampler;
evaluating values of the function h(x) at the sample values; and,
computing an estimate of the integral of the input function by summing the evaluated values of the function h(x).

2. The method according to claim 1, wherein encoding the probability function includes:
decomposing g(x) in a symmetrical product of one-dimensional functions. gᵢ(xⱼ);
discretizing each of the gᵢ(x) such that the number of points is equal to N, wherein N defines the number of channels of the sampler;
programming the first d rows of the unitary U of the boson sampler using gᵢ(xⱼ).

3. The method according to claim 1, wherein the encoding of the probability function includes decomposing the unitary U into a product of T_{m,n} matrices, a T_{m,n} matrix defining a lossless beam splitter between channel m and n with reflectively θ and phase shift φ.

4. The method according to claim 1, wherein the unitary U is implemented as programmable universal multiport interferometer.

5. The method according to according to claim 4, wherein the reflectivity and the phase shift parameters of the T_{m,n} matrices are used to program the probability function into the universal multiport interferometer.

6. The method according to claim 1, wherein the boson sampler is a Fock-state boson sampler, a Gaussian boson sampler, a scattershot boson sampler Bipartite boson sampler or a superposition boson sampler, or a boson sampling taking as its input any other quantum state of light.

7. A system for computing a Monte Carlo integral including classical computer connected to a boson sampler, the system being configured to:
receiving an input function, the input function being the product of a probability function g(x) that can be implemented by one or more calls to a programmable boson sampler and a function h(x) that can be evaluated by a classical computer, wherein the boson sampler is characterized by unitary U, a set of input quantum states and photodetection in a definite basis;
encoding the probability function into a boson sampler;
generating samples from the probability function based on the boson sampler;
evaluating values of the function h(x) at the sample values; and,
computing an estimate of the integral of the input function by summing the evaluated values of the function h(x).

8. The system according to claim 7, wherein encoding the probability function includes:
decomposing g(x) in a symmetrical product of one-dimensional functions. gᵢ(xⱼ);
discretizing each of the gᵢ(xⱼ) such that the number of points is equal to N, wherein N defines the number of channels of the sampler;
programming the first d rows of the unitary U of the boson sampler using gᵢ(xⱼ).

9. The system according to claim 7, wherein the encoding of the probability function includes decomposing the unitary U into a product of T_{m,n} matrices, a T_{m,n} matrix defining a lossless beam splitter between channel m and n with reflectively θ and phase shift φ.

10. The system according to claim 7, wherein the unitary U is implemented as programmable universal multiport interferometer.

11. The system according to claim 10, wherein the reflectivity and the phase shift parameters of the T_{m,n} matrices are used to program the probability function into the universal multiport interferometer.

12. The system according to claim 7, wherein the boson sampler is a Fock-state boson sampler, a Gaussian boson sampler, a scattershot boson sampler Bipartite boson sampler or a superposition boson sampler.

13. A computer program or suite of computer programs comprising at least one software code portion, the at least one software code portion, when run on a computer, being configured for executing the method steps according to claim 1.
